(19) United States
(12) Patent Application Publication
(10) Pub. No.: US 2019/0017827 A1
(43) Pub. Date: Jan. 17, 2019

(54) NOVEL VEHICLE-POSITIONING-AID TECHNOLOGY

(71) Applicant: 21F Enterprises LLC, Runaway Bay, TX (US)

(72) Inventor: Thomas Freeman, Runaway Bay, TX (US)

(73) Assignee: 21F Enterprises LLC, RUNAWAY BAY, TX (US)

(21) Appl. No.: 15/650,303

(22) Filed: Jul. 14, 2017

(51) Int. Cl. G01C 21/16

(52) U.S. Cl. CPC G01C 21/165

(57) ABSTRACT

A vehicle-positioning aid includes a field unit and a cab unit. The field unit is configured to generate a vehicle-contact signal when contacted by a vehicle and to wirelessly transmit a signal indicative that the field unit has be contacted by a vehicle. The cab unit is configured to provide the vehicle operator with an indication that the vehicle has contacted the field unit; for example, by emitting a particular sound pattern. The operator places the vehicle-positioning aid at a desired location on, for example, a work site, and is able to position the vehicle at the desired location by moving the vehicle until it contacts the field unit. Thus, the operator is able to position the vehicle at a desired spot without the need for other workers (spotters) to monitor the blind spots and relay information to the operator.

### BACKGROUND

This invention generally pertains to systems and methods for safely positioning and moving a vehicle in an area such as a worksite or parking lot. More specifically, it pertains to a portable electronic vehicle spotter having a transmitter and in communication with a receiver in the vehicle's driving cab. This spotter technology enables the operator of the vehicle to determine the position of the vehicle without the aid of human spotters.

Vehicle operators often must navigate blind spots when positioning or moving a vehicle. For example, the operator of a tractor-trailer unit may have to position the trailer at a spot on a worksite. Traditionally, the operator positions the unit with the aid of one or more other workers known as spotters. The spotters position themselves on the worksite such that they can see areas that the vehicle operator cannot and can also be seen by the vehicle operator. Through gestures and shouts, the spotters inform the operator whether it is safe and proper to move the trailer into the operator's blind spot. Safely moving the unit requires at least two workers, i.e., the operator plus one spotter. If sufficient spotters are not available, the vehicle cannot be safely moved. And assigning both a spotter and an operator to a vehicle will impose extra costs on the vehicle owner.

Accordingly, there is a need for technology that enables the vehicle operator to safely position and move a vehicle without the use of spotters.

### SUMMARY

The present invention is directed to technology that satisfies the need for a vehicle operator to safely move and position a vehicle without the use of spotters.

In one aspect of the invention, a vehicle-positioning apparatus includes a field unit, to be disposed outside the vehicle, and a cab unit, to be disposed with the vehicle operator. The field unit includes a base, a contact member extending upward from the base, and sensing, wireless communication, and control circuitry. The cab unit includes wireless communication and control circuitry. In use, the vehicle-positioning apparatus is placed at the desired location on, for example, the worksite or parking lot. The vehicle operator moves the vehicle until the vehicle contacts the field unit. On contact, the sensing circuitry in the field unit generates a signal that is passed via the control circuitry to the communication circuitry from whence a resulting signal is wirelessly transmitted to the cab unit. The communication circuitry in the cab unit receives the signal from the field unit which is collected (passively or actively) by the cab unit's control circuitry which in turn causes a resulting signal to be emitted over an emitter such as a lamp or speaker. The sensing circuitry of the field unit includes a contact sensor. This contact sensor may be, for example, an accelerometer or a biased switch that changes state when the field unit is contacted by the vehicle. The change of state corresponds to the signal generated on contact. The wireless communication circuitry of the field and cab units may be, for example, radio-frequency communication circuitry such as RF transmitter, receiver, and transceiver modules. These modules may be configured to communicate over well-known protocols such as Wi-Fi or Bluetooth, or may be configured to communicate via a proprietary protocol.

### BRIEF DESCRIPTION OF THE SEVERAL VIEWS OF THE DRAWINGS

These and other features, aspects, and advantages of the present invention will be become better understood with reference to the following description, appended claims, and accompanying drawings where:

FIG. 1 is a perspective view illustrating an exemplary embodiment of a vehicle-positioning aid according to the invention.

FIGS. 2a-2b are perspective views illustrating another exemplary embodiment of a vehicle-positioning aid according to the invention.

FIGS. 3a-3b are block diagrams of exemplary circuits of an exemplary vehicle-positioning aid according to the invention.

FIGS. 4a-4c are block diagrams of exemplary process flows of an exemplary vehicle-positioning aid according to the invention.

FIGS. 5a-5b are block diagrams of exemplary circuits and circuit components of an exemplary vehicle-positioning aid according to the invention.

FIGS. 6a-6b are block diagrams of exemplary process flows of an exemplary vehicle-positioning aid according to the invention.

FIG. 7 is a block diagram of an exemplary process flow of an exemplary vehicle-positioning aid according to the invention.

FIGS. 8a-8c are side and top views illustrating exemplary uses of exemplary vehicle-positioning aids according to the invention.

### DETAILED DESCRIPTION OF THE INVENTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

The term “accelerometer” is used herein to refer to the class of circuits that detect acceleration in one or more axes and may measure tilt, shock, or vibration. Accelerometers are well known in the art and are described in, for example, U.S. Pat. No. 5,005,413, No. 5,006,487, and No. 5,345,824. Commercial embodiments of accelerometers include, for example, the ADXL345 by Analog Devices.

The term “controller” is used herein to refer to the class of circuits that interface the components of a system, such as sensors and communication modules, to control operation of the system. Controllers are well known in the art and are described in, for example, Peter Spasov, Microcontroller Technology (1993). Commercial embodiments of controllers include, for example, the AduC7024 by Analog Devices.

The term “RF module” is used herein to refer to the class of circuits that transmit or receive radio-frequency signals. RF modules include transceiver modules, receiver modules, and transmitter modules. RF modules are well known in the art and are described in, for example, U.S. Pat. No. 6,374,079 and No. 7,245,884. Commercial embodiments of RF modules include, for example, the SP1ML, SPSGRF, SPBT3.0DP1, SPBT2632C1A, and SPWF01SA by STMicroelectronics.

The term “contact sensor” is used herein to refer to the class of sensors that generate a signal when the sensor, or an assembly in which the sensor is mounted, is contacted by an object. This includes, for example, accelerometers configured to detect motion caused by contact with an assembly in which the accelerometer is mounted and switches configured to change state (e.g., from open to closed or closed to open) when contacted.

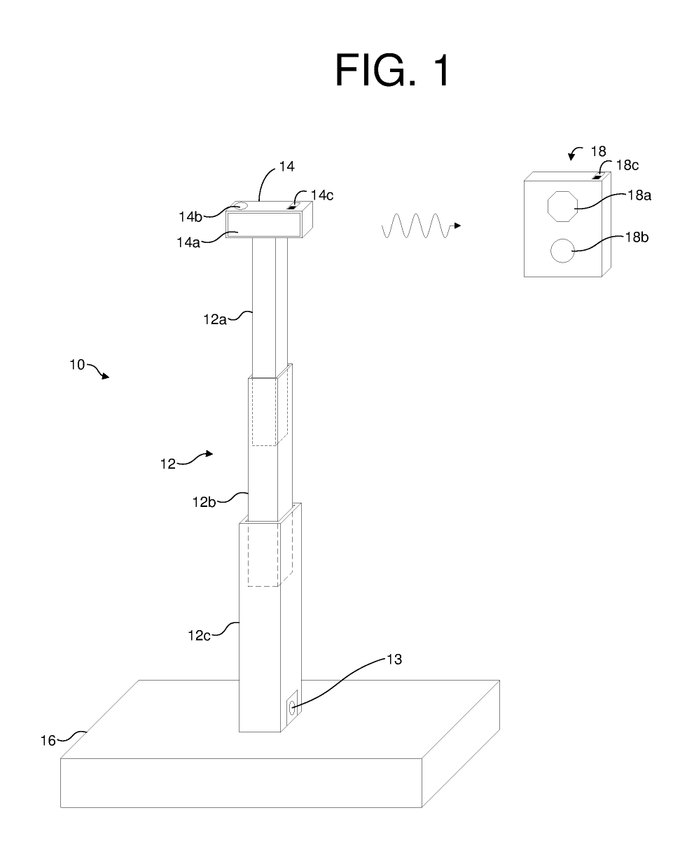

An exemplary vehicle-positioning aid is shown in FIG. 1. The aid includes a field unit 10 and a cab unit 18. The field unit 10 includes a base 16, a contact member 12, and a sensor unit 14. The contact member 12 extends up from the base 16 and may be rigidly connected to the base 16 or pivotally connected to the base 16 through, for example, a pin 13. The base 16 and contact member 12 may be constructed from a single piece or may be constructed separately and then assembled. For example, a pylon may serve as the base 16 and contact member 12. The contact member 12 may be of fixed length, wherein the sensor unit 14 would be located at a fixed height above the base 16. Alternatively, the length of the contact member 12 may be adjustable by the user. For example, the contact member 12 may include multiple telescoping members 12a, 12b, 12c that can be variably positioned with respect to each other to change the length of the contact member 12.

The sensor unit 14 includes a reflective surface 14a, an indicator lamp 14b, an on/off switch 14c, and sensing, wireless communication, and control circuitry. The chassis of the sensor unit 14 and the contact member 12 may be constructed from a single piece or may be constructed from separate pieces and then assembled. Likewise, the chassis of the sensor unit 14 may be formed from the same piece used to form a the contact member or a submember of the contact member. For example, the chassis of the sensor unit 14 may formed from the topmost telescoping member 12a of the depicted exemplary embodiment. In such an embodiment, the lamp 14b, on/off switch 14c, and sensing, wireless communication, and control circuitry would be assembled as part of one of the telescoping members 12a, 12b, 12c. Alternatively, all or part of the sensor unit may be in located in the base 16.

The cab unit 18 includes a speaker 18a, an indicator lamp 18b, an on/off switch 18c, and wireless communication and control circuitry. The cab unit 18 is configured to wirelessly communicate with the field unit 10. For example, wireless communication may be established via radio-frequency electromagnetic radiation using well-known RF modules. The cab unit 18 must include receiver capability (e.g., the RF module is a RF receiver or RF transceiver) and the field unit 10 must include transmitter capability (e.g., the RF module is a RF transmitter or RF transceiver).

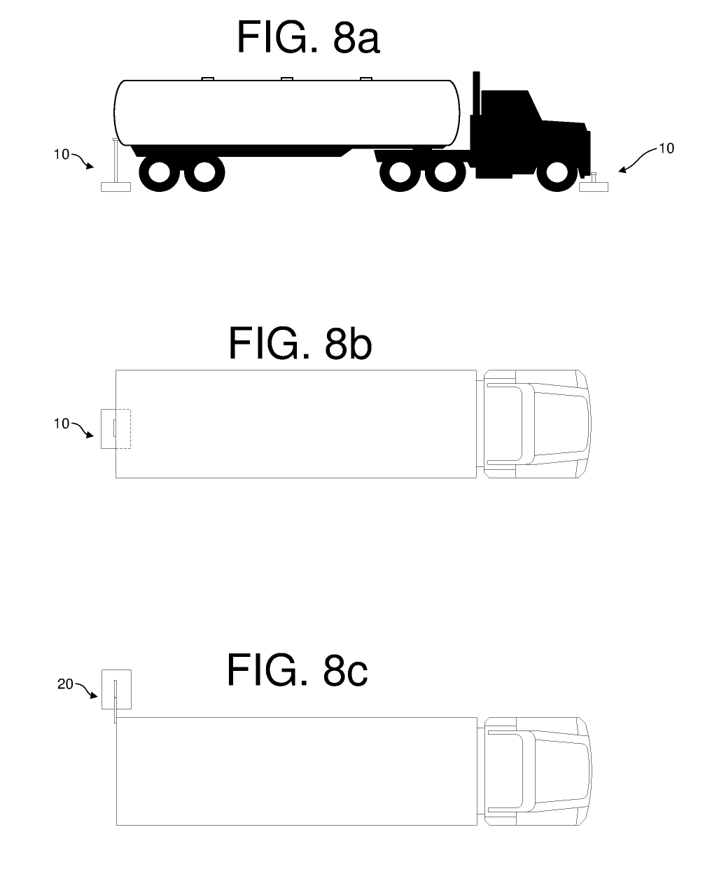

The use of the vehicle-positioning aid can be understood with reference to FIGS. 8a-8b. In operation, the field unit 10 is positioned on the work site or parking area such that the vehicle being positioned will touch, or bump, the contact member 12 or sensor unit 14 of the field unit 10 when moving into a restricted area. For example, the field unit 10 may be placed at some distance from a work-site feature (e.g., an oil or gas wellhead, a utility pole) such that a vehicle being positioned near the feature will touch the field unit 10 when the vehicle reaches the distance from the feature. When touched by the vehicle, the field unit 10 will transmit that fact to the cab unit 18. On receipt of this information, the cab unit 18 will notify the vehicle operator by playing a sound on the speaker 18a or changing the status of the indicator lamp 18b. Thus, the operator will know the position of the vehicle relative to the work-site feature and will not move the vehicle closer to the work-site feature. This will prevent undesired contact between the vehicle and the feature. Once the vehicle is positioned, multiple field units 10 may be placed around the vehicle such that subsequent movement of the vehicle will result in the vehicle touching one or more field units 10 and the operator being alerted. Thus, the operator must walk around the vehicle and collect the field units 10 before repositioning the vehicle. This will prevent the operator from moving the vehicle without first inspecting the surrounding area for safety hazards.

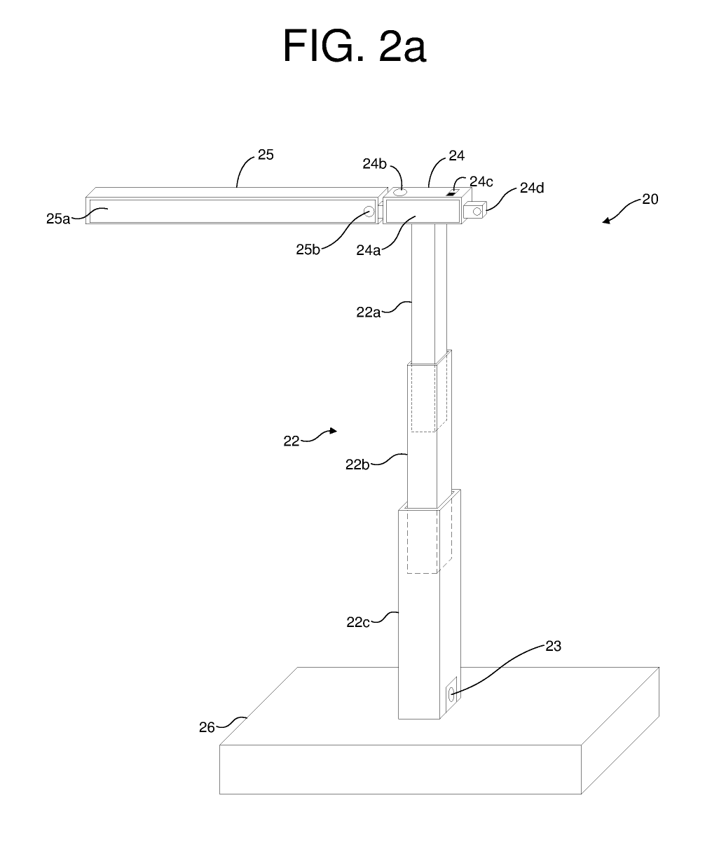

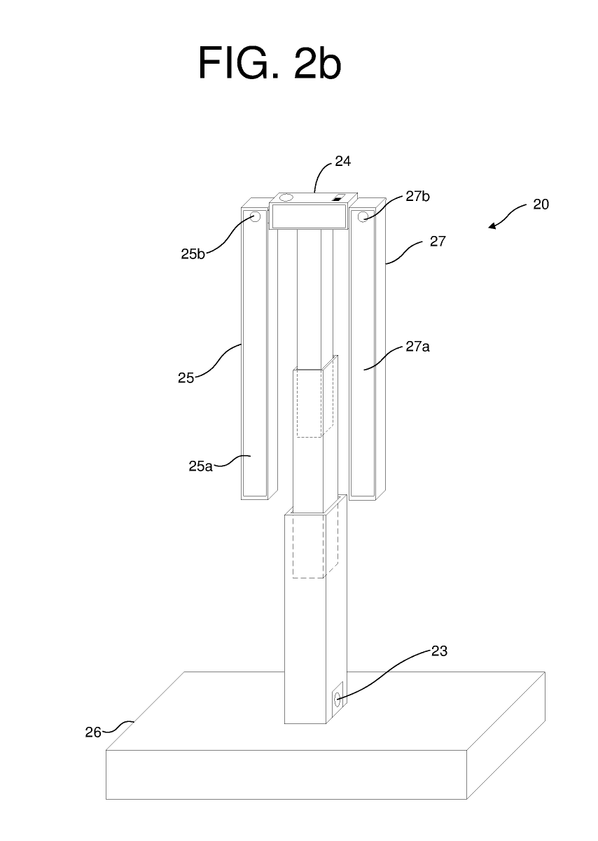

A field unit 20 of another exemplary vehicle-positioning aid is shown in FIGS. 2a-2b. Like the field unit 10 of FIG. 1, the field unit 20 of FIGS. 2a-2b includes a base 26, a contact member 22, and a sensor unit 24. The contact member 22 may include multiple telescoping members 22a, 22b, 22c and may be pivotally attached to the base 26 through a pivot pin 23. The sensor unit 24 includes a reflective surface 24a, an indicator lamp 24b, an on/off switch 24c, and sensing, wireless communication, and control circuitry. The sensor unit 24 also includes one or more extension mounts 24d extending from the sides of the chassis of the sensor unit 24. One or more extension members 25, 27, each with a reflective surface 25a, 27a, are connected to the sensor unit 24 via the extension mounts 24d. The extensions 25, 27 extend out from the sensor unit 24 and from the contact member 22 and may be rigidly connected to the sensor unit 24 or pivotally connected to the sensor unit 24 through, for example, a pin 25b, 27b. FIG. 2a illustrates an embodiment with one extension member 25 installed and extended. FIG. 2b illustrates an embodiment with two extension members 25, 27 pivotally connected to the sensor unit 24 and shown in a collapsed position.

The use of a vehicle-positioning aid with the field unit depicted in FIGS. 2a-2b is similar to that described above with reference to FIGS. 8a-8b. The difference is that the field unit 20 with extension members may be placed such that the vehicle will contact an extended extension member while a significant portion of the field unit is still visible to the vehicle operator whereas the filed unit 10 without extension arms will be placed such that it is predominantly in the operator's blind spot. FIG. 8c depicts a field unit 20 with an extension arm that is placed such that the field unit 20 is visible to the operator in the vehicle's driver-side mirror and the extension arm is extended to contact the vehicle when the vehicle reaches a certain position.

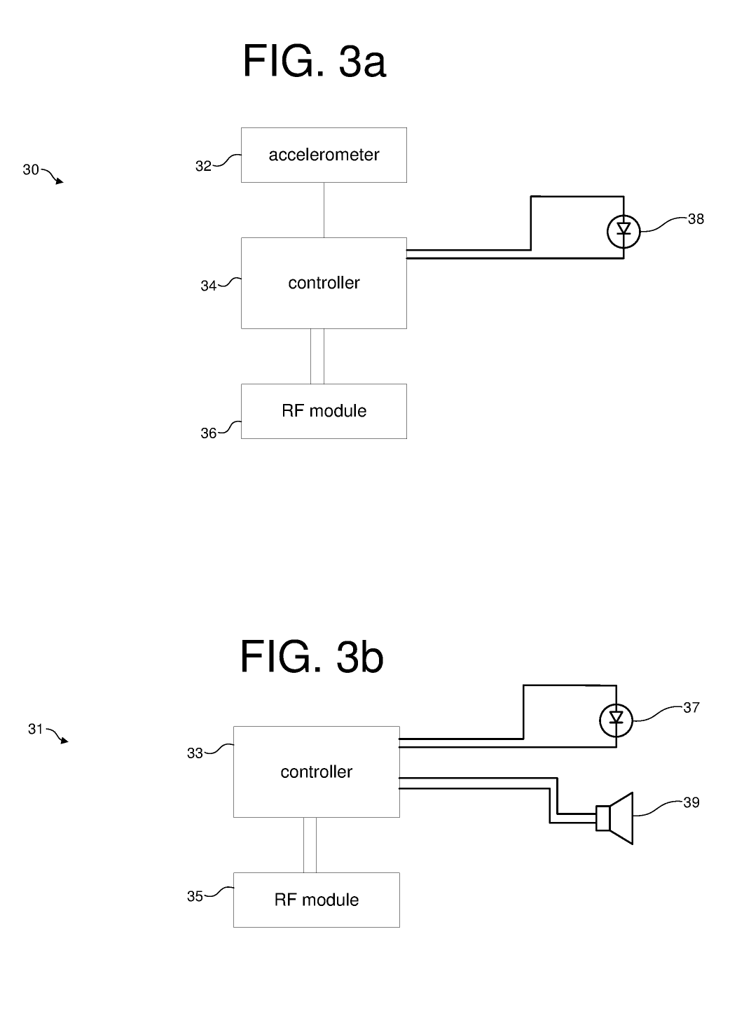

The block diagram shown in FIG. 3a illustrates an exemplary sensing, wireless communication, and control circuit 30 of a field unit. In this embodiment, the sensing circuit comprises an accelerometer 32. The accelerometer 32 measures changes in the motion or inclination state of the sensor unit. For example, when a vehicle bumps a field unit the accelerometer experiences an acceleration as the sensor unit changes from stationary to in-motion or from a first inclination to a second inclination. The change in the accelerometer's motion state is a signal indicating a vehicle has contacted the field unit (i.e., a vehicle-contact signal). The accelerometer 32 is connected to control circuitry 34. The controller 34 monitors the output of the accelerometer 32 and when the accelerometer 32 registers a change in its motion state (a vehicle-contact signal), the controller transmits that information to the cab unit via wireless module 36. The controller 34 also controls the status of an indicator lamp 38 (here, an LED). By controlling the output to, or current path of, the LED 38, the controller 34 can visually indicate the state of the sensor unit. For example, the controller 34 may set the voltage to the LED 38 at 0 volts for 1 second, then at 5 volts for 1 second and then continuously repeat to create a flashing light to indicate that the sensor unit is powered on. The controller 34 may maintain a steady 5-volt signal to the LED 38 to create a steady light to indicate that the controller is monitoring for a change in the accelerometer's motion state. The wireless module 36 implements the wireless transmission of information from the field unit to the cab unit. For example, the field unit may transmit: (1) an “init” signal to inform the cab unit that the field unit is powered on, (2) a “ready” signal to inform the cab unit that the field unit is ready to spot, and (3) a “spot” signal to inform the cab unit that the field unit has been bumped by the vehicle.

The block diagram shown in FIG. 3b illustrates an exemplary wireless communication and control circuit 31 of a cab unit. A wireless module 35 receives information from the wireless module 36 of the field unit. A controller 33 controls the status of an indicator lamp 37 (here, an LED) and a speaker 39 according to the information received from the field unit through the field unit's wireless module 36 and the cab unit's wireless module 35. By controlling the output to, or current path of, the LED 37, the controller 35 can visually indicate the state of the field unit. For example, the controller 33 may set the voltage to the LED 37 at 5 volts for 1 second, then at 0 volts for 1 second and then continuously repeat to create a flashing light to indicate that the cab unit is powered on. The controller 33 may maintain a steady 5-volt signal to the LED 37 to create a steady light to indicate that the cab unit has received a “ready” signal from the field unit. By controlling the output to, or current path of, the speaker 39, the controller can audibly indicate the state of the field unit. For example, the controller 33 may set the voltage to the speaker 39 at 5 volts for 1 second, then at 0 volts for 1 second, and then repeat the pattern until the cab unit receives a “ready” signal from the field unit. This will create a chirping pattern to inform the operator that the field unit is not ready. Once the “ready” signal has been received from the field unit, the controller 33 may set the voltage to the speaker 39 at a steady 0 volts, so that no sound is emitted. The controller 33 may set the voltage to the speaker 39 at 5 volts for 2 seconds, then 0 volts for 1 second, and then repeat the pattern three times to create a 3-chirp-pattern when the cab unit receives a “spot” signal from the field unit. This 3-chirp-pattern will inform the operator that the vehicle has bumped the field unit.

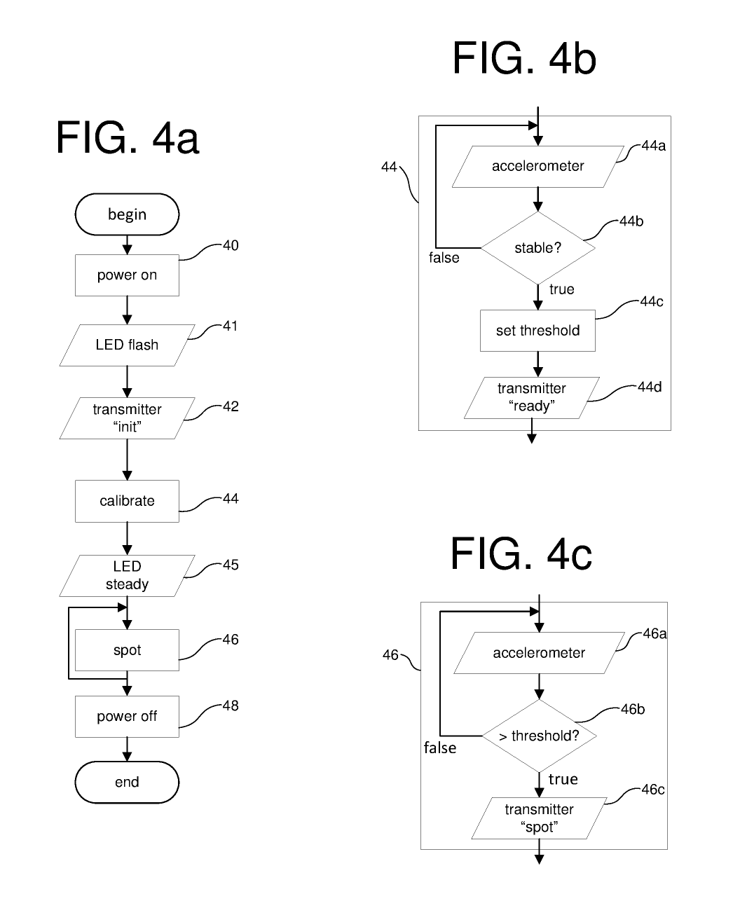

The flow diagrams of FIGS. 4a-4c illustrate an exemplary operational flow for the field unit. The field unit is powered on 40, the controller then causes the field unit's indicator lamp to flash 41, the controller sends an “init” signal to the cab unit 42, the controller then enters an accelerometer-calibrate process 44. When the accelerometer-calibrate process 44 is complete, the controller causes the field unit's indicator lamp to stay on 45 and then enters the spot process 46 until the unit is powered off 48.

In the accelerometer-calibrate process 44, shown in FIG. 4b, the controller reads the accelerometer information 44a then checks to see if the accelerometer is stable 44b. This is done, for example, by reading the accelerometer 30 times (e.g., at 1-second intervals) calculating the average reading of the 30 data points and also the maximum and average variance from the average reading, and then using the maximum and average variance data to determine if the accelerometer is stable. For instance, a maximum variance above a certain threshold would indicate that the accelerometer is not stable. So too would an average variance above a certain threshold. These variance thresholds would be set as part of a factory calibration. If the accelerometer is not stable, then the accelerometer will be read again (e.g., at the next 1-second interval). The average readings and variances will be recalculated after replacing the oldest accelerometer reading with the most-recent reading. This will be repeated until the maximum and average variances for the 30 most-recent data points are within the factory-set thresholds. Once the accelerometer is stable, a spotting threshold is set 44c. For example, the spotting threshold may be set as a multiple of the average variance or of the maximum variance of the 30-point accelerometer data set. Once the spotting threshold has been set, the controller sends a “ready” signal to the cab unit 44d.

In the spot process 46, shown in FIG. 4c, the controller reads the accelerometer information 46a then checks to see if the accelerometer reading is above the spotting threshold 46b. This is the spotting threshold set in the calibrate process 44. If the accelerometer reading is above the spotting threshold this indicates that the accelerometer reading has changed by some amount that indicates a vehicle bumped the field unit. For example, the accelerometer reading may indicate that the inclination of the field unit has changed, such as when a vehicle bumps the field unit and cause it to tilt. Similarly, the accelerometer reading may indicate that the field unit moved but did not necessarily change inclination, such as when a vehicle bumps the field unit and causes it to move but does not cause it to tilt. Once the accelerometer indicates that the field unit has been bumped by a vehicle, the controller sends a “spot” signal to the cab unit 46c.

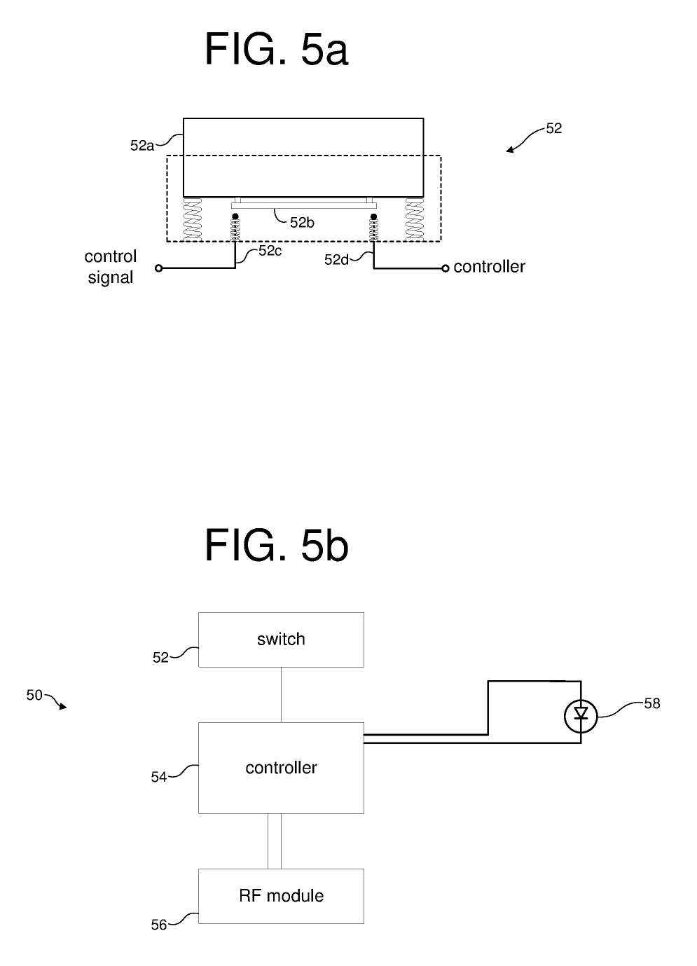

Another exemplary embodiment of sensing, wireless communication, and control circuitry 50 of a field unit is illustrated in FIGS. 5a-5b. In this embodiment, the sensing circuit comprises a push switch 52. The switch 52 includes an actuator 52a, a contact-connector plate 52b, a control-signal contact 52c, and a controller contact 52d. The exemplary switch 52 is a push-button normally-open switch: When the actuator 52a is pushed, the contact-connector plate 52b moves to contact both the control-signal contact 52c and the controller contact 52d. This places the switch 52 in the closed position, allowing electronic signals to flow from the control-signal contact 52a to the controller contact 52b and thus to the controller 54. This change in signal from the switch to the controller is a vehicle-contact signal in that it indicates a vehicle has contacted the field unit. When the force is no longer applied to the actuator 52a, the contact-connector plate 52b moves so that it no longer the contacts the control-signal contact 52c and the controller contact 52d. This returns the switch 52 in the open position, preventing electronic signals from flowing from the control-signal contact 52a to the controller contact 52b.

The switch 52 is positioned in the field unit such that when a vehicle bumps the field unit, force is applied to the actuator 52a and the switch 52 is placed in the closed position. For example, the switch may be placed in the sensor unit 14 or the contact member 12 of the field unit 10 illustrated in FIG. 1 such that the vehicle directly contacts the actuator 52a. The switch may also be placed such that force is applied to the actuator 52a by some other portion of the field unit when the vehicle bumps the field unit. For example, the switch may be placed in the base 16 of the field unit 10 such that when the contact member 12 pivots about pin 13, the contact member applies force to the actuator 52a. When the switch 52 is closed, the controller notes a change in the received control signal (a vehicle-contact signal) and interprets this as a vehicle bump and sends that information to the cab unit as a “spot” signal via the wireless module 56.

While this exemplary embodiment is shown with a push-button normally-open switch, biased switches of a different design may be used without departing from the spirit of the invention. For example, a push-button normally-closed switch may be used. In this instance, a vehicle bump will change the state of the control signal at the controller by opening the switch. Or a biased rotary switch may be used. For example, a biased rotary switch may be placed with its shaft linked to the pivotally mounted contact member 12 illustrated in FIG. 1. When the vehicle bumps the field unit, the contact member 12 pivots about the pin 13 causing a normally-open rotary switch to close, or a normally-closed rotary switch to open. Or a mercury switch may be used. In this instance, a vehicle-bump would cause the mercury to change position (e.g., by tilting or rising) thus closing or opening the switch.

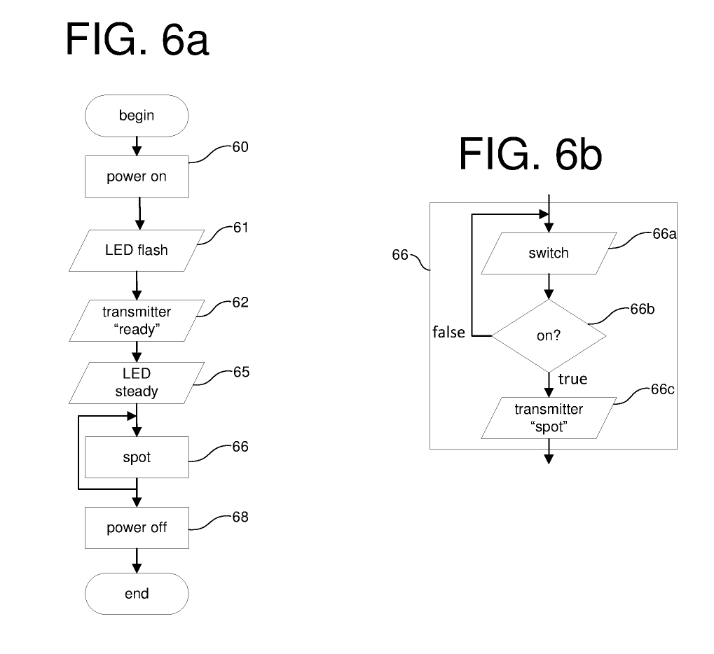

The flow diagrams of FIGS. 6a-6b illustrate an exemplary operational flow for the field unit. The field unit is powered on 60, the controller then causes the field unit's indicator lamp to flash 61, the controller sends a “ready” signal to the cab unit 62, the controller causes the field unit's indicator lamp to stay on 65, and then enters the spot process 66 until the unit is powered off 68.

In the spot process 66, shown in FIG. 6b, the controller reads the switch status by noting the state of the control signal at the controller 66b. If the switch is “on,” this indicates a vehicle bumped the field unit and either closed a normally-opened switch or opened a normally-closed switch. Once the switch status indicates that the field unit has been bumped by a vehicle, the controller sends a “spot” signal to the cab unit 66c.

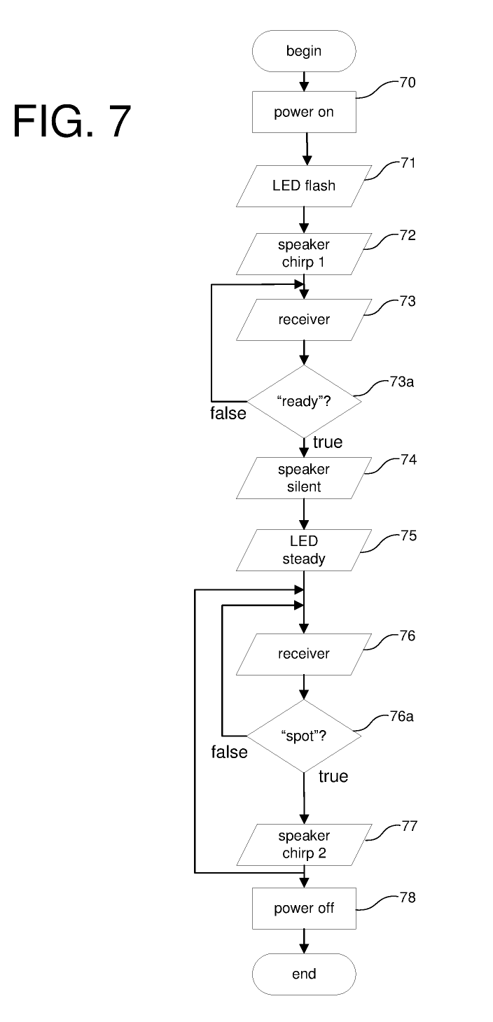

The flow diagram of FIG. 7 illustrates an exemplary operational flow for the cab unit. The cab unit is powered on 70, the controller then causes the cab unit's indicator lamp to flash 71 and the cab unit's speaker to chirp in a first pattern 72. The flashing lamp and the first chirp pattern inform the vehicle's operator that the field unit is not ready. The controller then monitors the wireless module 73 until it receives a “ready” signal 73a. Once the cab unit has received a ready signal from the field unit, the cab unit's controller silences the speaker 74 and causes the cab unit's indicator lamp to stay on 75. Then, the controller monitors the wireless module 76 until the unit is powered off 78. If the cab unit receives a “spot” signal 76a, the controller causes the speaker to chirp in a second pattern 77, to inform the vehicle's operator that the vehicle has bumped the field unit.

The cab unit may be implemented as a stand-alone unit or it may be implemented as an application on a device. For example, the cab unit may be implemented on a smartphone wherein the indicator lamp may be an LED on the smartphone or may be all or a portion of the smartphone's display screen.

The wireless modules may be any of a variety of RF modules, including modules to implement standard protocols such as the Wi-Fi or Bluetooth protocols.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A vehicle-positioning apparatus comprising:
(a) a field unit comprising:
(i) a base;
(ii) a contact member connected to and extending upward from the base;
(iii) a first RF module;
(iv) a first controller; and
(v) a contact sensor configured to generate a vehicle-contact signal if a vehicle contacts the field unit;
(vi) wherein the first controller is connected to the contact sensor and is configured to read signals generated by the contact sensor and to identify the vehicle-contact signal generated by the contact sensor; and
(vii) wherein the first controller is connected to the first RF module and is configured to transmit a spot signal via the first RF module if the first controller receives a vehicle-contact signal generated by the contact sensor; and
(b) a cab unit comprising:
(i) a second RF module;
(ii) a second controller; and
(iii) an emitter;
(iv) wherein the second controller is connected to the second RF module and is configured to receive information via the second RF module; and
(v) wherein the second controller is connected to the emitter and is configured to emit signals via the emitter; and
(c) wherein the first RF module is configured to transmit information to the second RF module and the second RF module is configured to receive information from the first RF module; and
(d) wherein the second controller is configured to emit a signal via the emitter on receipt of the spot signal from the field unit.

2. The vehicle-positioning apparatus of claim 1 wherein the contact sensor is an accelerometer and the vehicle-contact signal is a change in the accelerometer's motion or inclination.

3. The vehicle-positioning apparatus of claim 1 wherein the contact sensor is a biased switch and the vehicle-contact signal is a change in the biased switch's state.

4. The vehicle positioning apparatus of claim 3 wherein:
(a) the contact member is pivotally mounted to the base;
(b) the biased switch is configured to change state when the contact member pivots with respect to the base.

5. The vehicle-positioning apparatus of claim 1 wherein the first RF module and the second RF module are each Bluetooth modules.

6. The vehicle-positioning apparatus of claim 1 wherein the cab unit is a smartphone.

7. The vehicle-positioning apparatus of claim 1 wherein the cab unit is a tablet computer.

8. A vehicle-positioning apparatus comprising:
(a) a field unit comprising:
(i) a base;
(ii) a contact member connected to and extending upward from the base;
(iii) a generating means for generating signals when a vehicle contacts the field unit;
(iv) a transmitting means for wirelessly transmitting signals from the field unit;
(v) a means for reading signals generated by the generating means and causing signals to be transmitted by the transmitting means; and
(b) a cab unit comprising:
(i) a receiving means for wirelessly receiving signals from the field unit;
(ii) an emitter;
(iii) a means for receiving signals from the receiving means and causing signals to be emitted by the emitter.
